(19) United States
(12) Patent Application Publication
(10) Pub. No.: US 2019/0366793 A1
(43) Pub. Date: Dec. 5, 2019

(54) METHOD AND APPARATUS FOR CONTROL OF VEHICLE VENTILATION IN RESPONSE TO CARBON DIOXIDE ESTIMATION

(71) Applicant: GM GLOBAL TECHNOLOGY OPERATIONS LLC, Detroit, MI (US)

(72) Inventors: Derek Giordano, Lyon Township, MI (US); Todd M. Tumas, Taylor, MI (US)

(21) Appl. No.: 15/991,006

(22) Filed: May 29, 2018

(51) Int. Cl. B60H 1/00; B60H 3/00

(52) U.S. Cl. CPC B60H 1/008; B60H 1/00828; B60H 3/0085; B60H 1/00742

(57) ABSTRACT

The present application generally relates to control of vehicle cabin air recirculation in response to estimated carbon dioxide levels. In particular, the proposed method and apparatus use existing vehicle sensors to estimate carbon dioxide levels within a vehicle cabin to maximize internal cabin air recirculation in order to minimize the entry of outside harmful gases and reduce load on heating and air conditioning systems.

### BACKGROUND OF THE INVENTION

### Field of the Invention

The present application generally relates to control of vehicle cabin air recirculation in response to estimated carbon dioxide levels. In particular, the present application relates to estimating a vehicle cabin carbon dioxide level in response to stored data and traditional vehicle sensors in order to control a vehicle cabin ventilation schedule.

### Background Information

Passenger comfort in vehicle cabins is a primary driver of customer satisfaction for automobile manufacturers. Heating, cooling, humidity control and air freshness are all factors that contribute to passenger comfort. However, maintaining all of these factors simultaneously requires tradeoffs between performance and comfort. For example, cooling the cabin with air conditioning and introducing hot outside cabin air for freshness are counter productive.

Another tradeoff in vehicle cabin comfort is ventilation of fresh air to reduce carbon dioxide buildup from passenger respiration and introduction of outside noxious gases, such as carbon monoxide from vehicle exhaust, when circulating outside air into the cabin. There exists a need, therefore, for a method and apparatus for ventilating fresh air into vehicle cabins that addresses one or more disadvantages of the current state of the art discussed above.

### SUMMARY OF THE INVENTION

In accordance with an aspect of the present invention, an apparatus for controlling a carbon dioxide level in a vehicle cabin comprising a recirculation module for introducing outside air into the vehicle cabin having a recirculation state and an open state, a first sensor for determining an occupancy of the vehicle cabin, a memory for storing a vehicle cabin volume data, and a controller for estimating the carbon dioxide level in response to a duration of the recirculation state, the occupancy of the vehicle cabin and the vehicle cabin volume data, the controller operative to generate a control signal to switch the recirculating module to the open state in response to the estimation of the carbon dioxide level exceeding an upper threshold value.

In accordance with another aspect of the present invention, a method of controlling a carbon dioxide level in a vehicle cabin comprising determining an occupancy of a vehicle cabin, determining a duration of a recirculation mode of a recirculation module, retrieving a vehicle cabin volume data from a memory, estimating a vehicle cabin carbon dioxide level in response to an occupancy of the vehicle cabin, the duration of recirculation mode and the vehicle cabin volume data to generate an estimated vehicle cabin carbon dioxide level, and generating a recirculation module control signal in response to the comparison of the estimated vehicle cabin carbon dioxide level.

Additional features of the present invention will become apparent from the following description and appended claims, taken in conjunction with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an exemplary environment 100 of a vehicle cabin 105 for implementing the present disclosed systems and methods.

FIG. 2 shows a block diagram depicting an exemplary system for control of vehicle ventilation in response to carbon dioxide estimation.

FIG. 3 shows an exemplary flow chart depicting an exemplary method for control of vehicle ventilation in response to carbon dioxide estimation.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the control of vehicle ventilation in response to carbon dioxide estimation of the present disclosure has particular application for use on a vehicle. However, as will be appreciated by those skilled in the art, the method and apparatus of this disclosure may have other applications in systems outside of vehicles.

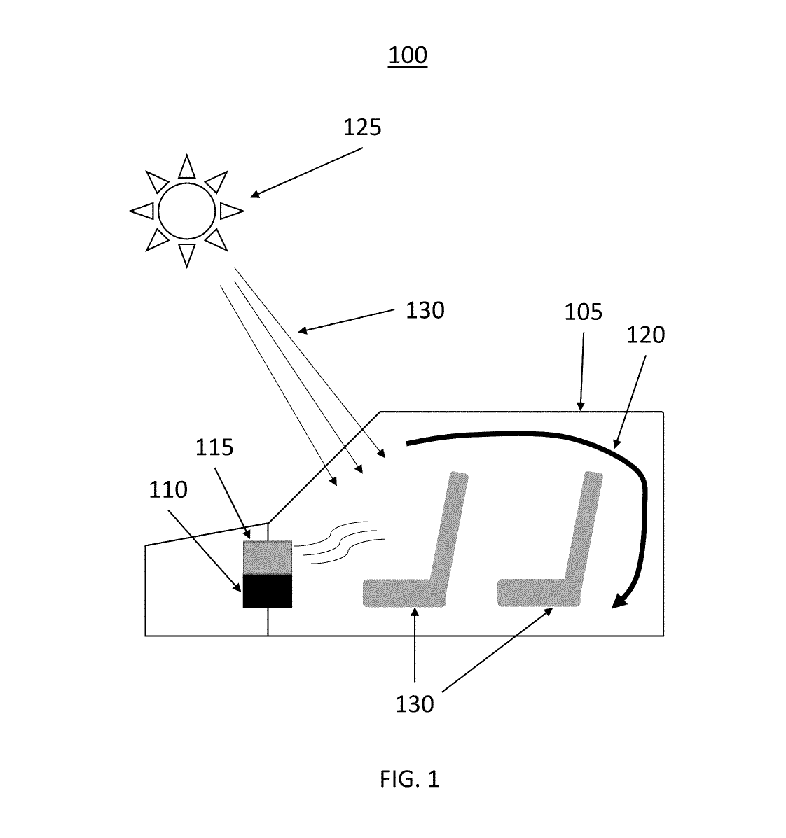

Turning now to FIG. 1 a diagram showing an exemplary environment 100 of a vehicle cabin 105 for implementing the present disclosed systems and methods is shown. The exemplary vehicle cabin 105 is shown with passenger seating 130, a heating and air conditioning system (HVAC) 110 and a recirculation module 115. In an exemplary application, the vehicle cabin 105 admits light energy 130 from the sun 125 into the vehicle cabin 105 which results in thermal energy and temperature increase within the vehicle cabin 105. To counter this thermal energy, the HVAC system 110 cools the vehicle cabin air are recirculates the vehicle cabin air 120. Passengers in the vehicle expel carbon dioxide CO2 when breathing and therefore, vehicle cabin air must be periodically refreshed by introducing outside air through the recirculation module 115, which is then typically passed through the HVAC system 110 and then introduced into the vehicle cabin 105. However, when outside air is introduced into the vehicle cabin 105, this air must be heated or cooled to the desired interior temperature and there places an additional strain on the HVAC system 110. In addition, noxious gases from outside of the vehicle are introduced into the vehicle cabin, such as carbon monoxide from vehicle exhaust, pollen and other allergens.

In order to minimize the introduction of outside air while reducing strain on the HVAC system 110 and reducing interior buildup of CO2, the system, and corresponding method, is operative to estimate the CO2 levels within the vehicle cabin based on detectable interior cabin factors, such as vehicle occupancy, cabin size, vehicle location and the like. The proposed system is advantageous does not require a costly CO2 sensor and it provides an accurate estimation of CO2 concentration due to occupant respiration without utilizing a CO2 sensor. For most applications, existing sensors in the vehicle HVAC system 110 and non-HVAC systems are utilized as inputs into the CO2 model.

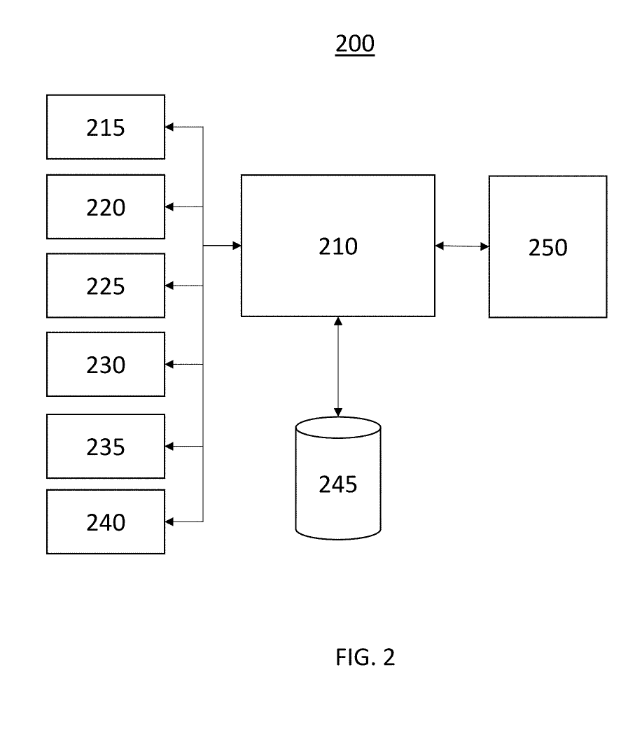

Turning now to FIG. 2, a block diagram depicting an exemplary system for control of vehicle ventilation in response to carbon dioxide estimation 200 is shown. The system includes an HVAC controller 210, a recirculation module 250, and a plurality of sensors. The sensors may include one or more of the following: occupancy detection sensor 215, HVAC fan speed detector 220, window and door state sensors 225, vehicle speed sensor 230, HVAC temperature door position sensor 235 and vehicle location sensor 240. In addition, the system is operative to store data in a memory 245, such as vehicle cabin volume, regional and local CO2 estimations, fan speed data, etc. This stored data, along with the data provided by the sensors provide the inputs into the CO2 model.

In an exemplary embodiment, the CO2 concentration over time is determined by the sum of the CO2 exhaled per minute by each occupant, plus the CO2 volume brought in from the outside including exchange through the recirculation module and vehicle cabin air leakage, plus the previous CO2 volume remaining after being displaced by incoming outside air. This sum is divided by the total interior breathable volume of the cabin to determine the CO2 concentration. It should be noted that all inputs do not have to be available to use the model. If an input is not present it is not used an average or worst-case value for CO2 build-up may be substituted. Once the estimated CO2 concentration exceeds a threshold value, the HVAC controller 210 controls the recirculation module 250 in order to introduce outside air with a lower CO2 concentration in order to reduce the interior CO2 concentration. Once the estimated CO2 concentration is below a

The breathable air volume is the air volume inside the cabin, which decreases per occupant resulting from the physical volume of each occupant. The outside CO2 concentration may be determined by comparing a lookup table stored in the memory 245 to a location determined through the vehicle location sensor 240, such as a global positioning system GPS signal, or may be determined in response to a regional or global average CO2 concentration. This location data or global average CO2 concentration may also be used as a starting cabin CO2 concentration depending on vehicle off time and last CO2 estimate. Uncontrolled leakage may be determined in response to vehicle speed, blower speed, and temperature setting. The HVAC fan speed may be requested as part of the thermal model or occupant selected. The CO2 exhaled rate is a standard value for a person at rest, per occupant. Weight of the occupants as determined by weight sensors within the sear may also be use do fine tune the CO2 exhaled rate. Any open door or window leakage rate is determined in response to window and door state sensors 225. Also, air exchange rate when a door or window is open is factored into the outside concentration in response to each open instance.

The system and method are operative to control a recirculation door within the recirculation module 250 in order to introduce outside air in response to CO2 concentration. When the CO2 concentration reaches an upper threshold value, the recirculation door opens to introduce outside air. When the CO2 concentration reaches a lower threshold value, the door closes and the HVAC system is once again operative to recirculate vehicle cabin air within the vehicle cabin.

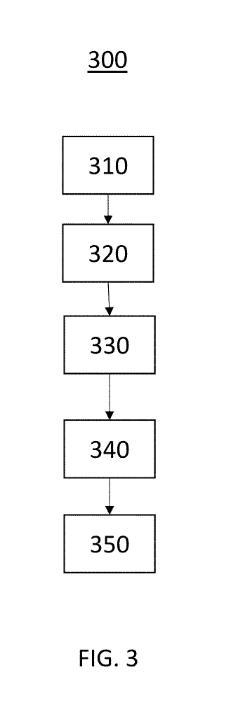

Turning now to FIG. 3, an exemplary flow chart depicting an exemplary method for control of vehicle ventilation in response to carbon dioxide estimation 300 is shown. The method is first operative to determining an occupancy of a vehicle cabin 310. This may be determined through the use of sensors in the vehicle seats, seat belts, or the like. The weight of the occupants may also be determined through the use of in seat sensors in order to more accurately estimate the CO2 generation of each occupant and the volume of cabin space taken up by each occupant, the estimated volume of each occupant to be subtracted from the vehicle cabin volume in order to determine the cabin volume available for air circulation.

The method is then operative to determine a duration of a recirculation mode of a recirculation module 320. The time duration facilitates the estimation of CO2 buildup over time within the vehicle cabin. Theoretically, the longer the ventilation system is in recirculate mode, the greater the concentration of CO2 within the vehicle cabin. In an exemplary embodiment, the duration may be determined during vehicle startup in response to timer set when the vehicle door is closed and the current time or a duration between a previous recirculation module open state and the current time.

The method is then operative to retrieve a vehicle cabin volume data from a memory 330. The memory may store the vehicle cabin volume or the like for access by an HVAC controller. Further, the HVAC controller may estimate the vehicle cabin volume usable for cabin air circulation by subtracting the estimated occupant volume from the total vehicle cabin volume.

The method is then operative to estimate a vehicle cabin carbon dioxide level 340. The vehicle cabin carbon dioxide level may be determined in response to the occupancy of the vehicle cabin 340, the duration of recirculation mode and the vehicle cabin volume data to generate an estimated vehicle cabin carbon dioxide level.

The method is then operative to generate a recirculation module control signal in response to the comparison of the estimated vehicle cabin carbon dioxide level 350. The method may be further operative to generate a control signal to control the recirculation module such that the recirculation module is in a recirculation mode when the estimated vehicle cabin carbon dioxide level is below a first level and an open mode when the estimated vehicle cabin carbon dioxide level is above a second level.

The method of claim 11 wherein the control signal is operative to control the recirculation module such that the recirculation module is in a recirculation mode when the estimated vehicle cabin carbon dioxide level is below a first level and an open mode when the estimated vehicle cabin carbon dioxide level is above a second level. The open mode introduces outside air into the vehicle cabin.

Optionally, the method may determine a fan speed of the recirculation module and wherein the estimating the vehicle cabin carbon dioxide level is made in response to the fan speed. In addition, the vehicle location may be used to estimate the outside CO2 levels and wherein this estimating of the outside CO2 level is used in estimating of the vehicle cabin carbon dioxide level is made in response to the vehicle location. Likewise, the method may determine a vehicle speed and wherein the estimating of the vehicle cabin carbon dioxide level is made in response to the vehicle speed. For example, if the vehicle is traveling at a high rate of speed, recirculation of cabin air may take less time than a vehicle that is stationary. The speed of the vehicle may be used in conjunction with the window state sensor to determine that a window is open and that the cabin air has been refreshed through the open window. Thus the method may determine a vehicle window state and wherein the estimating of the vehicle cabin carbon dioxide level is made in response to the vehicle window state.

The method may further be operative to store a carbon dioxide lookup table and wherein the estimating of the vehicle cabin carbon dioxide level is made in response to the lookup table. The method may estimate a vehicle cabin leakage and wherein the estimating of the vehicle cabin carbon dioxide level is made in response to the estimation of the vehicle cabin leakage Determining a vehicle location and wherein the memory is further operative to store an air quality location data and wherein the estimating of the vehicle cabin carbon dioxide level is made in response to the vehicle location and the air quality location data may be used to estimate the vehicle cabin CO2 level.

The exemplifications set out herein illustrate preferred embodiments of the invention, and such exemplifications are not to be construed as limiting the scope of the invention in any manner.

1. An apparatus for controlling a carbon dioxide level in a vehicle cabin comprising:
a recirculation module for introducing outside air into the vehicle cabin having a recirculation state and an open state;
a first sensor for determining an occupancy of the vehicle cabin;
a memory for storing a vehicle cabin volume data; and
a controller for estimating the carbon dioxide level in response to a duration of the recirculation state, the occupancy of the vehicle cabin and the vehicle cabin volume data, the controller operative to generate a control signal to switch the recirculating module to the open state in response to the estimation of the carbon dioxide level exceeding an upper threshold value.

2. The apparatus of claim 1 further comprising a fan speed sensor and wherein the estimation of the carbon dioxide level is made in response to a data from the fan speed sensor.

3. The apparatus of claim 1 wherein the controller is further operative to generate a control signal to switch the recirculating module to the recirculation state in response to the estimation of the carbon dioxide level being estimated to be less than a lower threshold value.

4. The apparatus of claim 1 further comprising a location sensor wherein the estimating of the carbon dioxide level is made in response to a data generated in response to the location sensor.

5. The apparatus of claim 1 further comprising a vehicle speed sensor wherein the estimating of the carbon dioxide level is made in response to a data generated in response to the vehicle speed sensor.

6. The apparatus of claim 1 further comprising a window state sensor and the estimating of the carbon dioxide level is made in response to a data generated in response to the window state sensor.

7. The apparatus of claim 1 wherein the memory is operative to store a carbon dioxide lookup table and the controller being further operative to estimate the carbon dioxide level in response to the lookup table.

8. The apparatus of claim 1 wherein the controller is further operative to estimate a vehicle cabin leakage estimation and wherein the estimating of the carbon dioxide level is made in response to the vehicle cabin leakage estimation.

9. The apparatus of claim 1 further comprising a location sensor for generating a location data and wherein the memory is further operative to store an air quality location data and wherein the estimating of the carbon dioxide level is made in response to the location data and the air quality location data.

10. The apparatus of claim 1 further comprising estimating a carbon dioxide generation data in response to the occupancy of the vehicle cabin and wherein the estimating of the carbon dioxide level is made in response to the carbon dioxide generation data.

11. A method of controlling a carbon dioxide level in a vehicle cabin comprising;
determining an occupancy of a vehicle cabin;
determining a duration of a recirculation mode of a recirculation module;
retrieving a vehicle cabin volume data from a memory;
estimating a vehicle cabin carbon dioxide level in response to an occupancy of the vehicle cabin, the duration of recirculation mode and the vehicle cabin volume data to generate an estimated vehicle cabin carbon dioxide level; and
generating a recirculation module control signal in response to the comparison of the estimated vehicle cabin carbon dioxide level.

12. The method of claim 11 wherein the control signal is operative to control the recirculation module such that the recirculation module is in a recirculation mode when the estimated vehicle cabin carbon dioxide level is below a first level and an open mode when the estimated vehicle cabin carbon dioxide level is above a second level.

13. The method of claim 11 wherein the open mode introduces outside air into the vehicle cabin.

14. The method of claim 11 further comprising determining a fan speed of the recirculation module and wherein the estimating the vehicle cabin carbon dioxide level is made in response to the fan speed.

15. The method of claim 11 further comprising determining a vehicle location and wherein the estimating of the vehicle cabin carbon dioxide level is made in response to the vehicle location.

16. The method of claim 11 further comprising determining a vehicle speed and wherein the estimating of the vehicle cabin carbon dioxide level is made in response to the vehicle speed.

17. The method of claim 11 further comprising determining a vehicle window state and wherein the estimating of the vehicle cabin carbon dioxide level is made in response to the vehicle window state.

18. The method of claim 11 wherein the memory is operative to store a carbon dioxide lookup table and wherein the estimating of the vehicle cabin carbon dioxide level is made in response to the lookup table.

19. The method of claim 11 further comprising estimating a vehicle cabin leakage and wherein the estimating of the vehicle cabin carbon dioxide level is made in response to the estimation of the vehicle cabin leakage.

20. The method of claim 11 further comprising determining a vehicle location and wherein the memory is further operative to store an air quality location data and wherein the estimating of the vehicle cabin carbon dioxide level is made in response to the vehicle location and the air quality location data.
